(19) United States
(12) Patent Application Publication
(10) Pub. No.: US 2002/0153044 A1
(43) Pub. Date: Oct. 24, 2002

(54) Automatic water level controller with plural outlet float valve

(76) Inventor: Hak Jae Lee, Kyunggi-do (KR)

Correspondence Address: Stephen A Pendorf, Pendorf & Cutliff, PO Box 20445, Tampa, FL, 33622-0445, US

(21) Appl. No.: 10/111,825

(22) PCT Filed: Aug. 31, 2001
(86) PCT No.: PCT/KR01/01481

(30) Foreign Application Priority Data
Aug. 31, 2000 (KR) 2000/24699 U

(51) Int. Cl. F16K 31/18

(52) U.S. Cl. 137/442

(57) ABSTRACT

The present invention relates to a float valve of an automatic water level controller for controlling the water level of various fluids. In particular, the present invention relates to a float valve of an automatic water level controller, which has plural outlets and is capable of controlling the water level. The present invention employs the plural outlets and is structured such that if a floating ball rises, a first valve is opened and a second valve is accordingly opened at a low water pressure. Therefore, a space can be maximally used by making the floating ball smaller or a supporting rod shorter. In addition, the present invention has an advantage of having no tendency to be contaminated by using a synthetic resin, having no possibility to be frozen to burst by achieving a low heat conductivity and providing consumers with economic profit by reducing manufacturing cost.

### TECHNICAL FIELD

The present invention relates to an automatic water level controller for a water tank, which is installed within a water tank to operate a valve of a water supplying tube according to a water level in the tank, thereby supplementing a water.

### BACKGROUND ART

In general, a device for controlling a water level in a tank is structured to open and close a valve in a water supplying tube by raising and dropping a floating ball according to the water level in the tank, such that if water is filled in the water tank, the floating ball rises to shut off the valve, thereby stopping a water supply, while if water is drained, the floating ball slopes toward a lower side to open the valve, thereby further supplying a water to the water tank.

The present invention relates to a water level controller comprising a water supplying tube which includes a float valve installed on an upper side of a water tank. A conventional float valve is structured in such a manner that a supporting rod raises and drops a water blocking aperture while rotating about a binge by upward and downward operations of a floating ball. Thus, the blocking operation is subject to a rise of the floating ball. Further, the most serious disadvantage of the structure is that a water pressure and a buoyant force conflict with each other. That is to say, the conventional float valve has a disadvantage that when the water pressure is high, the water level rises since the buoyant force always intends to rise and the water pressure always intends to be work downward, whereby there exists a constant force to conflict. The conventional float valve has another disadvantage that there is needed a strong material, such as brass, since the buoyant force gathers on a connecting part with a body. The conventional float valve has still another disadvantage that a fluid is uninterruptedly discharged until being blocked from outside in case of a breakdown caused for example when the buoyant ball is separated from a supporting rod.

### DISCLOSURE OF INVENTION

It is an object of the present invention to provide a water level controller which can maximize efficiency in using a space by providing a water supplying tube with a plurality of outlets, using additional valves for opening the respective outlets to open the water supplying tube with a small power and thus making a floating ball smaller or a supporting rod shorter.

It is another object of the present invention to provide a water level controller, which can prevent pollution by using a floating ball materialized of a synthetic resin.

It is still another object of the present invention to provide a water level controller, which can ensure an enough safety not to be frozen to burst by achieving a low heat conductivity.

It is yet another object of the present invention to provide a water level controller, which can reduce manufacturing costs.

To accomplish the above-mentioned object of the present invention, there is provided an automatic water level controller including: a supporting rod, whereon a floating ball is installed, penetrating through one side of a water supplying tube and being fixed with a hinge; valves being installed within the water supplying tube to open and close the water supplying tube according to a pivotal rotating movement of the supporting rod; plural outlets being installed within the water supplying tube, wherein the valves are installed in the respective outlets; valve switches being installed on an end part of the supporting rod to open and close the valves by raising the same, wherein the valves are operated with a weaker force in a manner that a length of a first valve switch raising a first valve is longer than a second valve switch raising a second valve, and when a floating ball moves downward, the first valve is opened to drop a water pressure and afterwards the second valve is opened.

### BRIEF DESCRIPTION OF THE DRAWINGS

Further objects and advantages of the invention can be more fully understood from the following detailed description taken in conjunction with the accompanying drawings, in which:

FIG. 1a to FIG. 1c illustrate a view of an automatic water level controller according to the present invention;

FIG. 1a illustrates a schematic view of a state where a valve is closed;

FIG. 1b illustrates a schematic view of a state where a first valve is opened;

FIG. 1c illustrates a schematic view of a state where a second valve is opened;

FIG. 2 illustrates a schematic view of other preferred embodiment of a valve according to the present invention;

FIG. 3 illustrates an exemplary view of a state where the automatic water level controller of the present invention is applied to a household toilet.

### BEST MODE FOR CARRYING OUT THE INVENTION

Further objects and advantages of the invention can be more fully understood from the following detailed description taken in conjunction with the accompanying drawings.

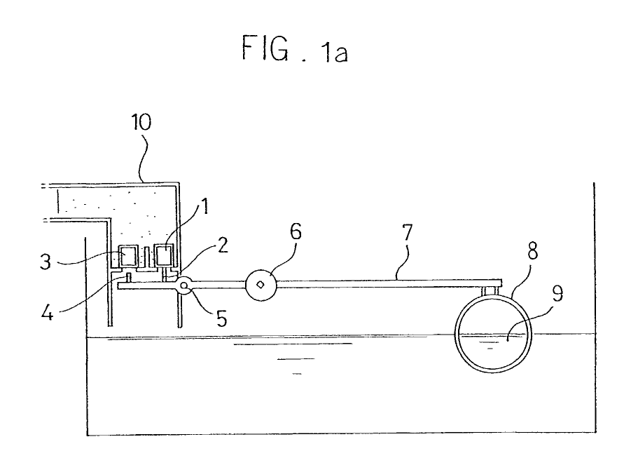

FIG. 1a to FIG. 1c illustrate a schematic view of an inside of the tank including an automatic water level controller according to the present invention, wherein a water supplying tube 10 has two outlets.

That is, in case of embodying the present method with an outlet, a supporting rod should be longer or the floating ball should be heavier. However, the present invention solved the problem by employing a lever principle.

More specifically, two outlets are formed inside the water supplying tube 10. The supporting rod 7 is fixed on and penetrates through one side of the water supplying tube 10 with a hinge while the supporting rod being positioned lower than the outlets.

In each outlet, valves 1 and 3 are positioned and the valves 1 and 3 move upward and downward in a same position, thereby closing and opening the outlets.

On one end of the supporting rod 7, a floating ball 8 is installed, and on the other end of the supporting rod 7, valve switch 2 and 4 are installed to raise the valves 1 and 3.

In addition, a water level controller 6 is installed in the middle of the supporting rod 7 to control a wanted water level by controlling a height of the floating ball 8.

According to the present invention constructed as above, a weaker force is needed than the conventional method when the first valve switch 2 is opened about the hinge 5 which is a point of application in the lever principle. This is because a length of the valve switch 2 can be apparently reduced about the point of application.

At that time, the first valve switch 2 is longer in length than the second valve switch 4, SO that a first valve 1 can be opened when the floating ball 8 moves downward.

When the first valve 1 is opened, the inner pressure drastically drops and a second valve 3 is consecutively controlled after the first valve 1, whereby weaker force of the floating ball 8 is sufficient for the opening. A better method to easily practice the above is to fill a heavy material such as water 9 or sand to the floating ball 8.

According to the present invention, since a gravity is influenced to the floating ball 8, it is easy to open the valves 1 and 3. Since there exists some amount of air inside the floating ball 8, the valves 1 and 3 are closed if the water level reaches a wanted level.

That is, the present invention is a structure using a gravity and a buoyant force. The characteristic of this structure is that if a heavy force is loaded on one side about the point of application in the lever principle, the other side should be longer or heavier. Thus, the present invention can make the length of the supporting rod 7 shorter by filling water 9 or sand into the floating ball 8, whereby the efficiency in use even in a small space is enhanced when the valves 1 and 3 are installed and operated.

In addition, the valves 1 and 3 and the valve switch 2 and 4 are separably designed not as one integral body, so that when the water flows into the water tank from outside, the floating ball 8 rises upward in a state that the valves 1 and 3 are blocked, thereby not influencing to the whole structure of the valve.

Another advantage of the present invention-is that the water level control is easily achievable, in contrast to other float valves. In the existing method, the water level was partially controlled by forcibly bending the supporting rod made of brass. However, according to the present invention, the water level controller 6 is installed on the supporting rod 7 by adjusting the wanted level to a level that a user wants and then by fixing the water level by means of a screw, etc., so as to control the stream of a fluid at the water level wanted.

In addition, a spring is installed on an upper part of the valves 1 and 3 to prevent the valves 1 and 3 from not being well closed when the water pressure is weak.

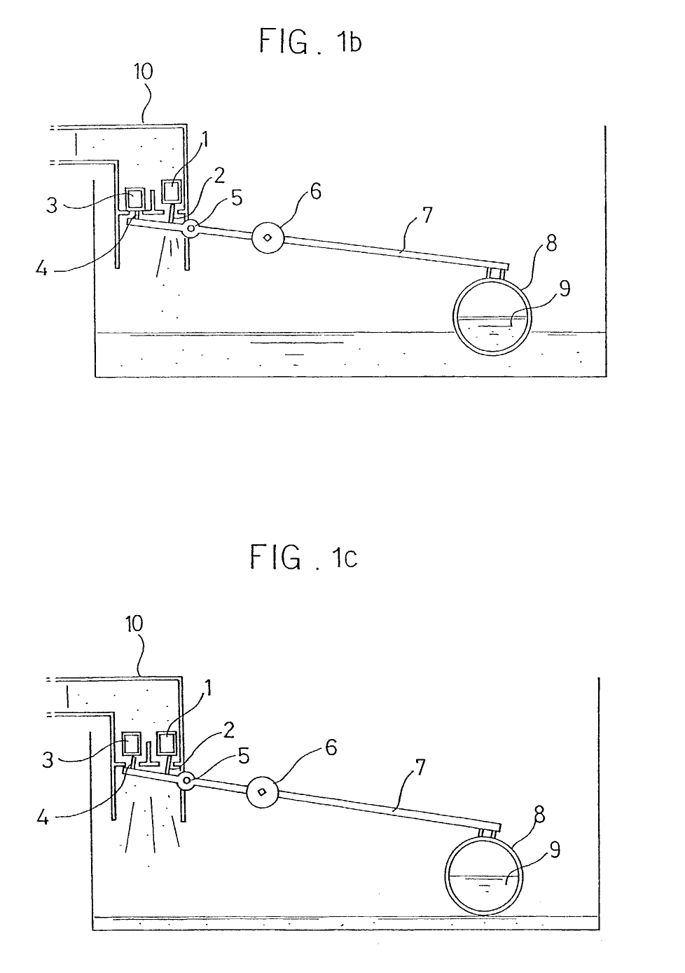

Further, to solve the problem in case that the water pressure in the water supplying tube 10 is low, as illustrated in FIG. 2, a magnet 20 is attached on a lower surface of the valves 1 and 3 and an iron ring 21 is additionally installed on a portion whereon the valves 1 and 3 contact, thereby ensuring a perfect airtight effect by using a cohesiveness of the magnet and the iron.

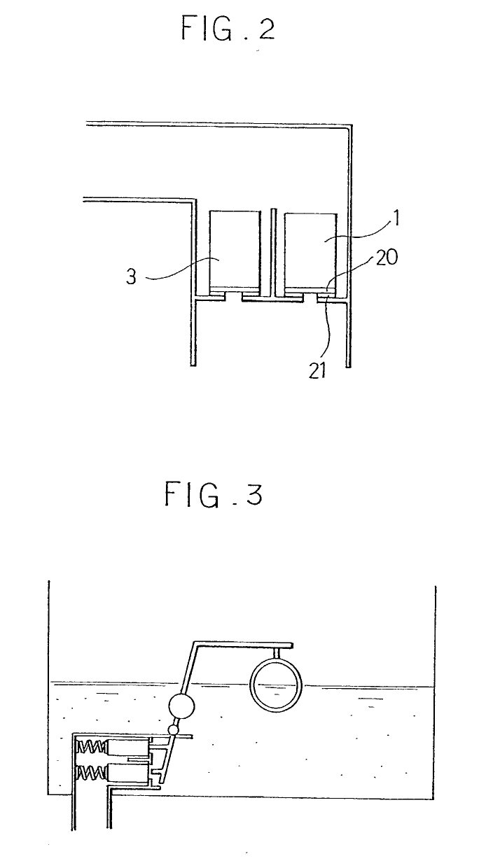

Additionally, if an inlet hole is directed downward, it can be used as a household toilet, as illustrated in FIG. 3. In that case, a noise can be eliminated while the water is filled since the water is supplied under water, differently from the conventional method. In the conventional method, a noise occurs when being mixed with an air since the water drops after rising. However, the present invention has an advantage of not producing any noise since the water comes out under the water.

Industrial Applicability

The present invention can achieve a mass production since a supporting rod, etc. can be made of a synthetic resin, have a strong contamination-proofness, and have a safety of not being frozen to burst since a heat conductivity is lower than that of metal products. In addition, a user can obtain an economic advantage, since the manufacturing cost is cheap as well as making a use of a space to be maximum by making a floating ball smaller and a length of the supporting rod shorter.

In addition, in an existing method, a water level varies according to the water pressure. However, the present invention has another advantage of maintaining a pre-determined water level without any change in the water level according to the water pressure.

In addition, the present invention has further another advantage of preventing the water from flowing to outside since a valve is blocked even in the event of a breakdown caused due to a case that a floating ball is separated from the supporting rod.

What is claimed is:

1. An automatic water controller comprising:
a supporting rod, whereon a floating ball is installed, penetrating through one side of a water supplying tube and being fixed with a hinge;
valves being installed within the water supplying tube to open and close the water supplying tube according to a pivotal rotating movement of the supporting rod;
plural outlets being installed within the water supplying tube, wherein the valves are installed in the respective outlets;
valve switches being installed on an end part of the supporting rod to open and close the valves by raising the same,
wherein the valves are operated with a weaker force in a manner that a length of a first valve switch raising a first valve is longer than a second valve switch raising a second valve, and when a floating ball moves downward, the first valve is opened to drop a water pressure and afterwards the second valve is opened.

2. The controller of claim 1, wherein water or sand is filled in the floating ball to shorten the length of the supporting rod.

3. The controller of claim 1, wherein a spring is additionally installed on an upper part of the valves to ensure an easy operation under a low pressure.

4. The controller of claim 1, wherein a magnet is attached on a lower surface of the valves and an iron ring is additionally installed on a portion whereon the valves contact, to ensure an easy operation under a low pressure by using a cohesiveness of the magnet and the iron.

5. The controller of claim 1, wherein a water level controller is additionally installed on the supporting rod to achieve an easy water level control according to a user's demands.

6. The controller of claim 1, wherein an inlet hole of the water supplying tube is installed on a lower surface of a water tank to be usable as a toilet.
